(19) United States
(12) Patent Application Publication
(10) Pub. No.: US 2015/0031349 A1
(43) Pub. Date: Jan. 29, 2015

(54) DRIVER DISTRACTION DISABLING VIA GESTURE RECOGNITION

(71) Applicant: Kyllburg Technologies, LLC, Tempe, AZ (US)

(72) Inventors: Hakim Hill, Tempe, AZ (US); William Birgen, Tempe, AZ (US)

(73) Assignee: Kyllburg Technologies, LLC, Tempe, AZ (US)

(21) Appl. No.: 14/338,735

(22) Filed: Jul. 23, 2014

Related U.S. Application Data
(60) Provisional application No. 61/859,105, filed on Jul. 26, 2013.

(51) Int. Cl. H04M 1/725

(52) U.S. Cl. CPC H04M 1/72577; H04M 1/72569
USPC 455/418

(57) ABSTRACT

A method and system for preventing distracted driving caused by mobile devices are disclosed. The method and system may determine whether a user is driving by the traveling speed and the gestures of the user. In addition, the orientation of the mobile device may be used for detecting whether the user is a driver.

### CROSS-REFERENCE TO RELATED APPLICATION

The present application claims priority to co-pending U.S. provisional patent application entitled “Driver Distraction Disabling via Gesture Recognition,” having Ser. No. 61/859,105, filed on Jul. 26, 2013, which is entirely incorporated herein by reference.

### BACKGROUND

Distracted driving is dangerous and sometimes fatal. In 2011, up to 10% of fatal auto collisions were reported as distraction-affected crashes in the U.S. For drivers under the age of 20, 21% of the fatal, distraction-related crashes involve the use of cell phones at the time of the collisions. Many states now outlaw texting while driving. But laws alone are not enough to deter some drivers. To prevent distracted driving, an effective way may be to limit the use of cell phones by disabling the distracting features. Existing systems and methods use servers or additional devices to identify whether the user is driving. Consequentially, these systems and methods incur extra costs to the users. It is desirous to utilize the computing power and features of a mobile device to prevent drivers from distractions.

### SUMMARY

The structure, overall operation and technical characteristics of the present invention will become apparent with the detailed description of preferred embodiments and the illustration of the related drawing as follows.

The invention is incorporated in a method and a system with interconnected software and a mobile device that detect whether a user of the mobile device is driving above a certain speed that serious, or even fatal, accidents are likely to happen. For the purpose of this application, a “mobile device” should be broadly considered to include various handheld devices, such as cell phones, handheld game consoles, portable media players, personal digital assistants (PDAs), mobile internet devices (MIDs), mobile televisions, and any other hand-held device that can transmit text messages and related information. If the user is found driving, certain distracting features of the mobile device may be temporarily disabled by a lock-out mechanism of the mobile device. The distracting features may include texting, youtube, emails, movies, and so forth. When the features are disabled, a message may be displayed to inform the user of the temporary disablement.

The mobile device may include a motion detector to detect the traveling speed and to determine whether the traveling speed is beyond a certain, predefined threshold level, such as 10 miles/hour, which indicates that the user may be driving. The traveling speed of the user means an instantaneous speed of the mobile device, rather than an average speed over the course of the journey. The location of the mobile device may be sampled at a certain frequency such as several times a minute so that the traveling speed can be constantly updated. Alternatively, the speed may be determined with a global positioning system (GPS) or any other means known to a person skilled in the art. For example, the vehicle may be able to communicate with the mobile device of its traveling speed. If the traveling speed is lower than the speed at which statistically crashes may cause serious injuries, such as when a driver stops at a red light, then the user may be allowed to use the distracting features.

In addition to the traveling speed, indications of whether a user is driving include the gestures of the user, the objects near the user, and the orientation of the mobile device being used. The mobile device may include a user interaction analyzer to detect these driver indications. For example, user gesture identification consistent with driving may include identifying movements and positions of the user's eyes, head, shoulders, and hands, and any combinations thereof. Objects near the user may be used to identify whether the user is sitting in the driver seat. As to the orientation of the mobile device, a driver is not likely to tilt the mobile device flat against her lap when using the device. Therefore, if a user uses the mobile device with the screen facing up, the user is less likely the driver.

One embodiment may identify the user gestures based on images taken by its cameras. Gestures of a driver are different from a passenger's. In an embodiment with a rearward facing camera and facial recognition software for distinguishing the user's face from all of the objects comprising the background scenery (the interior components of the vehicle and the objects outside the vehicle), or for identifying when the user's face tilt changes in a nodding motion, the user interaction analyzer of the embodiment may decide that the user is a driver. Another embodiment with an eye movement tracking sensor may detect that the user is a driver by identifying an up and down darting motion of the user's eye. Alternatively, if a user interaction analyzer automatically takes pictures of the user every 10 seconds, identifies the objects in the pictures, and finds in a picture that at least one of the user's hands rests on the steering wheel (a part of the background scenery), then the user interaction analyzer may determine that a driver gesture is detected. Similarly, various combinations of eye, head, hand, and shoulder movements and positions may be used for identifying whether the user is driving.

Additionally, the relative positions of the objects may indicate where the user is sitting in a vehicle. Examples of the objects include an instrument cluster, a steering wheel, the road, other vehicles, and so forth. An embodiment may use a forward facing camera to captures images for identifying the objects. When the embodiment identifies from the image a certain shape that resembles a part of an instrument cluster, the user may be sitting in the driver seat and therefore a driver. Also, if a steering-wheel-like object appears or the meeting of the dashboard with the windshield in the image taken by the forward facing camera, the embodiment may determine that the user is holding the mobile device while driving. Another example is a road with road markings delineating the lanes, if the marking on the left is closer to the user, the user may be sitting in the driver seat (in most countries). Various embodiments may use various objects and combinations thereof to identify the user's seat.

Finally, the orientation of the mobile device may be used by the user interaction analyzer of the mobile device to distinguish a driver from passengers. One embodiment may use an orientation sensor, such as an accelerometer in a smart phone, to detect the angle of the mobile device. If the mobile device is placed against a user's lap, the user is less likely a driver. But if the screen of the mobile device is facing away from the direction of travel, and the mobile device is inclining forward within 45 degrees of vertical angle, the user may be a driver.

One object of this invention is to identify whether the user is driving while using a mobile device and to disable the distracting features of the mobile device, while allowing the use of the mobile device by passengers.

One object of this invention is to prevent distracted driving involving mobile devices while certain emergency uses are still allowed.

Another object of this invention is to provide a low cost system and method for effectively preventing distracted driving caused by a mobile device while not incurring extra cost for additional devices or services specially designed to identify a driver.

### BRIEF DESCRIPTION OF THE DRAWINGS OR PICTURES

FIG. 1 is a flow chart of one embodiment.

### DESCRIPTION OF THE EMBODIMENTS

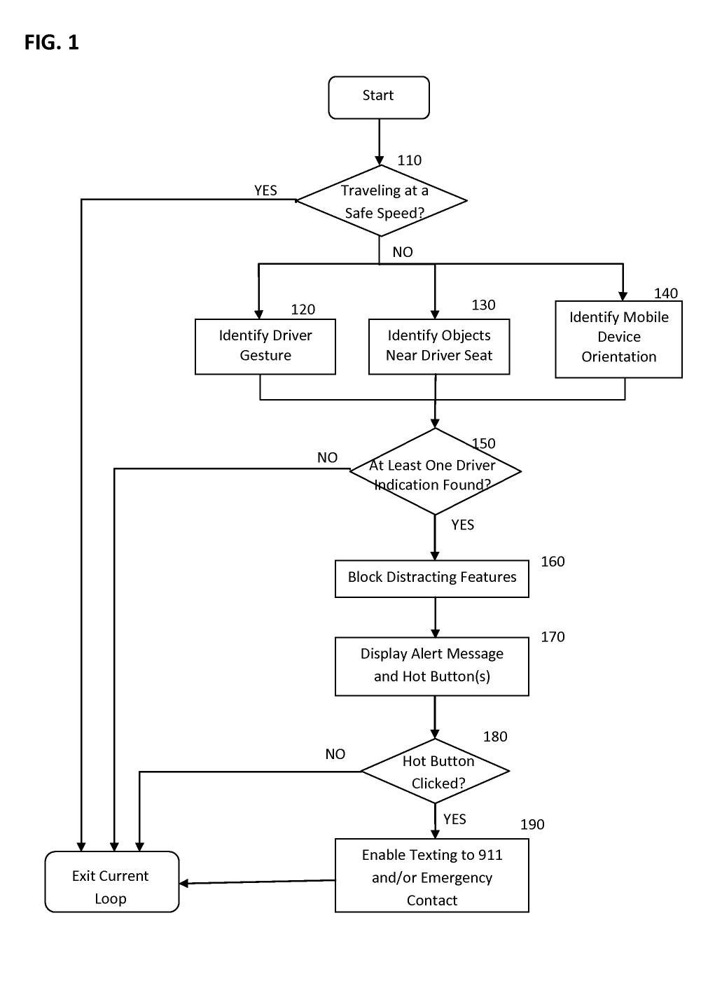

The preferred embodiments are a method and a mobile device for preventing distracted driving by disabling distracting features of the mobile device. The preferred method is illustrated in FIG. 1. The mobile device preferably comprises a motion detector, a user interaction analyzer, a lock-out mechanism, a GPS receiver, and forward and rearward facing cameras. The mobile device may incorporate the preferred method in FIG. 1 to identify the driver and disable features of the mobile device that may be distracting.

In Step 110 of FIG. 1, the preferred method first detects the traveling speed of the mobile device by a motion detector. If the motion detector find that the speed exceeds a certain threshold (e.g. 5 miles per hour, the safe speed being a predetermined number), the user may be traveling in a vehicle at an unsafe speed and the first criterion 110 is met. The threshold is preferably a fixed number above which a collision may result in serious injuries or death, or the threshold may be configurable by the user via a user interface.

For a preferred embodiment with a GPS receiver, the motion detector may determine the traveling speed of the mobile device by measuring the Doppler shift in the GPS signals from the satellites. The signals from the satellites change depending on how fast the mobile device is moving towards or away from the satellites. The more satellites the GPS receiver can track, the more accurate the calculated traveling speed is. For another embodiment with a cell phone as the mobile device, the traveling speed of the mobile device may be determined by the distance and location of cell towers by the motion detector.

The preferred embodiment may then use the user interaction analyzer to detect whether the user is a driver by various driver indications. The first indication is based on a predefined set of driving gestures—user gestures detected in Step 120 that are consistent with driving. The preferred embodiment may adopt a rearward facing camera and facial recognition software for detecting the orientation of the user's face. If the tilt of the user's face changes in a nodding motion, the user may be a distracted driver. If the user blocks the camera, the user may be a driver who tries to circumvent the detection.

In another embodiment with a rearward facing motion sensor, the motion sensor may also detect a nodding motion which can be used to determine that the user is driving. Moreover, if an embodiment is equipped with an eye motion sensor, the user's up and down darting motion may indicate that she is a driver. Various embodiments may use one or more gesture matches with the predetermined driver gestures as a pass of this criterion.

In Step 130, the preferred embodiment may identify objects generally seen from a driver seat but not from a passenger seat for determining where the user is sitting. The preferred embodiment with a forward facing camera may take pictures of the environment the user is facing. Based on the shapes of objects in the pictures, the embodiment may determine that the objects match those generally seen from a driver seat, thus meeting the criterion. The objects used may include things in the vehicle such as the steering wheel, the instrument cluster, the dashboard, the meeting of the dashboard and the windshield, or any parts of these objects. Things outside the vehicle may also be used, such as the road and other vehicles. The criterion in various embodiments may require only one match or multiple matches.

Some environmental issues may affect the effectiveness of Steps 120 and 130. An example would be when it is night, it may be too dark for the embodiments to recognize the user's gestures or the objects around the user. Therefore, another driver indication may be necessary. The preferred embodiment also adopts the orientation of the mobile device to detect by the user interaction analyzer whether the user is a driver. If the screen is facing away from the direction of travel and tilting slightly forward, such as being within 45 degrees of vertical angle or any predetermined range of orientations of a driver's mobile device, the user may be the driver. On the contrary, if the user is a passenger, the user may tilt her device flat against her lap, with the screen facing up. Smart phones generally are equipped with accelerometers for determining orientation.

For an embodiment with a smart phone as the mobile device or having an orientation sensor, the embodiment may determine by the user interaction analyzer that the user is a driver when the device is not facing up. In the preferred embodiment illustrated in FIG. 1, if the user interaction analyzer detects any of the indications 120, 130 and 140, the user is determined a driver. But in other embodiments, the indication in Step 140 may not be adopted at all or only be adopted when no driver indications are found in Steps 120 and 130.

If the criteria 110 and 150 are met, the preferred embodiment in FIG. 1 disables by the lock-out mechanism certain predefined features of the mobile device 160 and displays a message to inform the user that these applications are disabled in Step 170.

The message may be “pull over and stop if you wish to text” when the distracting feature disabled is texting with a cell phone. In addition, the lock-out mechanism may include at least one hot button for emergency situations in Steps 180 and 190. The hot button may be pre-defined to allow the user to text or contact 911 or an emergency contact person. It is preferred that the emergency contact is established with the service provider so that the user cannot circumvent the blocking.

The preferred embodiment in FIG. 1 may be performed repeatedly by the mobile device so that the mobile device automatically and selectively disables the distracting features when the user begins driving and re-enables these features when the user stops or drives at a low speed. The frequency of performing this method may be configured to a fixed frequency or an embodiment may conduct the detections more frequently when the user is found driving faster than the threshold speed. The distracting features may be predetermined or be configured via a user interface. Moreover, when the user is found not driving, and the lock-out mechanism of the preferred embodiment is about to enable the previously disabled distracting features, the embodiment may show a message such as “for your safety, do not text and drive” just in case the user somehow circumvents the blocking logics.

In addition, alternate embodiments may adopt some but not all of the criteria in FIG. 1, test the criteria in various sequences, and determine by the mobile device that a user is driving even if not all criteria adopted are satisfied. Also, the alternate embodiments may adopt other means to indicate that some features are disabled or not display any alert message at all. Additionally, for embodiments that detect traveling speed by the motion detector with GPS sensors, the user interface for deactivating GPS may be disabled to avoid user's blocking the embodiments.

While the invention has been described by means of specific embodiments, numerous modifications and variations could be made thereto by those ordinarily skilled in the art without departing from the score and spirit disclosed herein.

### REFERENCES

1. U.S. Patent Publication No. 20130005443 by James Peter Kosta et al.
2. U.S. Patent Publication No. 20120306770 by Christopher Moore et al.
3. U.S. Pat. No. 8,235,529 by Hayes Solos Raffle et al.
4. U.S. Pat. No. 8,254,960 by Chi-Sheng Ge.
5. PCT Publication No. WO2012089901 A1 by Nokia Corp.

1. A mobile device comprising:
a) a motion detector configured to determine whether a traveling speed of a vehicle in which the mobile device is located exceeds a predefined threshold level;
b) a user interaction analyzer configured to detect at least one driver indication; and
c) a lock-out mechanism configured to automatically and selectively disable at least one predefined feature of the mobile device based on outputs of the motion detector and the user interaction analyzer.

2. The mobile device of claim 1, wherein the lock-out mechanism is further configured to disable the at least one predefined feature when the traveling speed exceeds the predefined threshold level and the at least one driver indication is detected.

3. The mobile device of claim 1, wherein the at least one driver indication is found when the user interaction analyzer detects a driving gesture of a user of the mobile device.

4. The mobile device of claim 3 further comprises a camera configured to automatically take at least one picture of the user for the user interaction analyzer to determine whether the at least one driver indication is detected.

5. The mobile device of claim 3, wherein the driving gesture is determined based on a movement of a user body part.

6. The mobile device of claim 3, wherein the driving gesture is determined based on a position of a user body part relative to at least one object of a background scenery.

7. The mobile device of claim 1, wherein the at least one driver indication is found when an orientation of the mobile device falls into a predetermined range of orientations of a driver's mobile device.

8. The mobile device of claim 7 further comprises an orientation sensor configured to determine the orientation of the mobile device.

9. The mobile device of claim 1, wherein the lock-out mechanism is further configured to allow a limited emergency use of the disabled at least one predefined feature.

10. A method for preventing driving distraction, the method comprising the steps of:
a) a mobile device determining a traveling speed of a vehicle in which the mobile device is located;
b) the mobile device detecting at least one driver indication; and
c) the mobile device automatically and selectively disabling at least one predefined feature of the mobile device when the traveling speed exceeds a predefined threshold level and the driver indication is detected.

11. The method of claim 10, wherein the at least one driver indication is found when the mobile device detects a driving gesture of a user of the mobile device.

12. The method of claim 11 further comprises the steps of:
a) the mobile device automatically taking at least one picture of a user of the mobile device by a camera; and
b) the mobile device determining whether the driving gesture exists based on the at least one picture.

13. The method of claim 11, wherein the driving gesture is determined based on a movement of a user body part.

14. The method of claim 11, wherein the driving gesture is determined based on a position of a user body part relative to at least one object of a background scenery.

15. The method of claim 10, wherein the at least one driver indication is found when the mobile device detects that an orientation of the mobile device falls into a predetermined range of orientations of a driver's mobile device.

16. The method of claim 15 further comprises the step of:
the mobile device determining the orientation of the mobile device by an orientation sensor.

17. The method of claim 10 further comprises the step of:
the mobile device automatically enabling a limited emergency use of the disabled at least one predefined feature.

18. A mobile device for preventing distracted driving comprising:
a) a motion detector configured to determine whether a traveling speed of a vehicle in which the mobile device is located exceeds a predefined threshold level;
b) a user interaction analyzer configured to detect at least one driver indication by the group consisting of:
1) determining whether a user gesture matches at least one predefined driving gesture based on at least one picture of a user automatically taken by a camera,
2) determining whether an orientation of the mobile device falls into a predefined range of orientations of a driver's mobile device, and
3) combinations thereof; and
c) a lock-out mechanism configured to automatically and selectively disable the at least one predefined feature of the mobile device based on outputs of the motion detector and the user interaction analyzer.

19. The mobile device of claim 18, wherein the lock-out mechanism is further configured to disable the at least one predefined feature when the traveling speed exceeds the predefined threshold level and the at least one driver indication is detected.

20. The mobile device of claim 18, wherein the lock-out mechanism is further configured to allow a limited emergency use of the disabled at least one predefined feature.
